(19) United States
(12) Patent Application Publication
(10) Pub. No.: US 2012/0248106 A1
(43) Pub. Date: Oct. 4, 2012

(54) Collapsible Locking Container

(76) Inventor: Eric Costa Marta, Humble, TX (US)

(21) Appl. No.: 13/077,437

(22) Filed: Mar. 31, 2011

(51) Int. Cl. B65D 8/14; B23P 11/00

(52) U.S. Cl. 220/8; 29/428

(57) ABSTRACT

A multi-purpose container with a generally cylindrical shape having multiple section which can be added or removed or expanded or collapsed to vary the size and capacity of the container. The container having a plurality of tabs and channels which allow it to be locked in an open, closed or semi open position with a twisting motion of the sections in relation to each other.

### BACKGROUND OF THE INVENTION

Traditional cans or pails are fabricated to withstand rough handling. Most are not foldable or collapsible and pose a storage problem when transported due to their size. Those that have been manufactured to be foldable or collapsible lack the stability necessary to provide reliable containment, often collapsing at inopportune moments such as when full. Cans that have stability can be difficult to close when it is desirable to do so. Another problem occurs when attempting to transport a collapsed container which opens of its own accord.

### BRIEF DESCRIPTION OF THE DRAWINGS

FIG. 1 shows an exploded perspective view of a collapsible storage container in accordance with an exemplary embodiment of the invention.

FIG. 2 shows a perspective view of a collapsible storage container in the collapsed position in accordance with an exemplary embodiment of the invention.

FIG. 3 shows a perspective view of a collapsible storage container in the expanded and locked position in accordance with an exemplary embodiment of the invention.

FIG. 4 shows a top view of a collapsible storage container in accordance with an exemplary embodiment of the invention.

FIG. 5 shows a side view of a collapsible storage container in the collapsed position with attached base unit and lid in accordance with an exemplary embodiment of the invention.

FIG. 6 shows an exploded side view of a collapsible storage container with rolling base and lid in accordance with an exemplary embodiment of the invention.

FIG. 7 shows an exploded side view of a shipping tube in accordance with an exemplary embodiment of the invention.

FIG. 8 shows a perspective view of a shipping tube in the expanded configuration in accordance with an exemplary embodiment of the invention.

FIG. 9 shows a perspective view of a shipping tube in the collapsed configuration in accordance with an exemplary embodiment of the invention.

### DETAILED DESCRIPTION OF THE PREFERRED EMBODIMENTS

Herein described is a collapsible storage container. The container is fashioned from a plurality of substantially vertically oriented flat wall panels curved to form proximately cylindrical shapes, or rings, which are concentric and adjacently spaced to one another. Each panel, except for the inner most panel has a plurality of tabs spaced around the bottom open end and projecting from the inner wall toward the axis for a distance of less than the thickness of the adjacent panel. Each panel, except for the outer most panel, has a plurality of channels oriented vertically along the sides of the panel from the end nearest the tab to the distal end in a substantially straight line and stopping just short of the top and bottom ends. Each channel is angled from the vertical at the distal ends to run substantially horizontally for a distance of at least half the width of the channel. The plurality of panels are concentrically oriented about a central vertical axis and sized such that the tab of the outer most of each pair mates and engages with the channel of the inner most of each pair. The panels are capable of being extended or retracted vertically telescopically for raising and lowering the panels causing the storage container to alter configuration between an expanded and collapsed position.

As one skilled in the art would appreciate, these panels could be reversed such that the outer most panel forms the bottom of the storage container and the inner most panel forms the top of the storage container. However, doing so would provide a container which has a larger area at the bottom than at the top, and which could cause items to possibly stick in the container. For that reason, traditional containers have either straight sides or sides that taper toward the bottom. Thus, that is how this storage container is presented throughout this description.

The outer most panel has a plurality of optional handles, and the inner most panel has a substantially closed lower end. The container may further comprise an optional base attachment for stability and fastening of casters for mobility. In another embodiment the optional base may be an extension of and form a part of the inner most panel functioning as its substantially closed lower end. The container may further comprise a cover or lid which may be locked, fastened, or otherwise removably secured to the outermost panel in manners already known by one skilled in the arts. Such manners may include, but are not limited to, friction, threads, or latching.

The container may be fashioned from any moldable, machineable, or manufacturable material. The container may be configured as any type of storage container in which portability and collapsibility is desirable. In one embodiment the container is configured as a trashcan of approximately 35 gallons to be used for hunting and camping trips where it is desirable to have a securable trash container which can be closed against critters when not in use, and collapsed for storage in a vehicle or camper when not in use. In another embodiment the container is configured as a yard-can of approximately 60 gallons or more to be used for gathering leaves and lawn debris where it is desirable to have a larger capacity for hauling sparsely packed items, such as leaves, and yard waste and where collapsibility would aid in storage and transport of such a large unwieldy container. In another embodiment the container is configured as a mailing tube of approximately 18 inches when stored and capable of being used in that fashion, or of having one or more sections extended to give options of holding items in a protected fashion that are approximately 24 inches, 36 inches or longer in length. In another similar embodiment there could be a plurality of horizontal side channels along the main vertical channel to allow locking the mailing tube in a larger configuration of lengths. The preferred embodiment is a trash can of approximately a 10 to 40 gallon capacity with three to five total sections being manufactured from moldable plastic and having an oversized bottom for stability and a securable lid.

In each of the above embodiments, the container is extended to an expanded position by causing the tabs to slide along the channels of the next inner most section until the container reaches an expanded state, then rotating the sections around a center axis relative to one another to cause the tabs to divert into the side channels and thus not be aligned with the vertical channel such that the container could slide back to a collapsed state. In another embodiment the side channel may contain a drop, depression, or locking mechanism such as, a spring or pin which further secures the panel in the rotated position until released by the user.

To return the container to a collapsed state, the sections are rotated relative to one another such that the tabs are diverted from the side channels and align with the vertical main channel and the sections are lowered into each other in a concentric and telescopic fashion, and once lowered to the collapsed state the sections are again rotated to cause the tabs to divert into the side channels and thus not be aligned with the vertical main channel such that the container could not slide back to the expanded position.

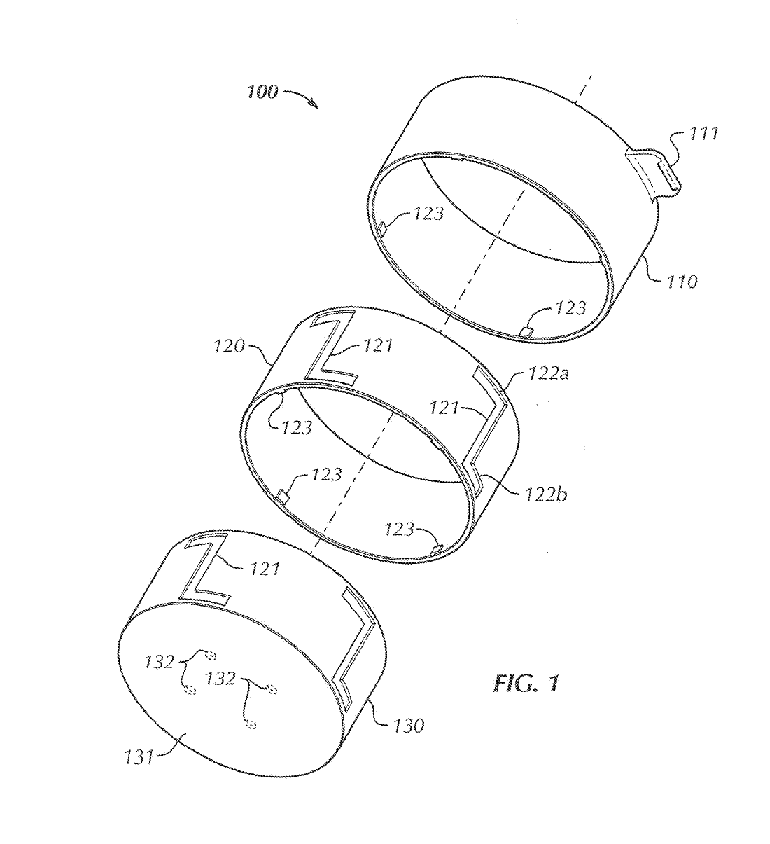

FIG. 1 shows an exploded perspective view of a collapsible storage container in accordance with an exemplary embodiment of the invention. The container (100) is illustrated with a plurality of panels (110, 120, and 130) concentric and adjacently spaced to one another. The outer most panel (110) and the intermediate panels (120) have a plurality of tabs (123) spaced around the inside walls. The inner most panel (130) and the intermediate panels (120) have a plurality of channels (121) oriented outer sides of the panels and angled at each end (122a and 122b). The inner most panel (130) has a substantially closed lower end (131) which has optional base attachment points (132). It should be noted that the tabs'(123) on the insides of the intermediate panels (120) do not directly align with the channels (121) on the outside of the same intermediate panel (120). This is done to ensure the integrity of the material forming the panels, as positioning them in alignment on opposite sides of the walls could cause a weak point in the material and could create a structural failure of the panel walls. Also by offsetting the tab to be opposite the angled channel, this causes the channels of adjacent panels to align when the tab is twisted into the side channel creating an aesthetically pleasing alignment of the channels down the side of the expanded container and giving a visual confirmation of the locking state.

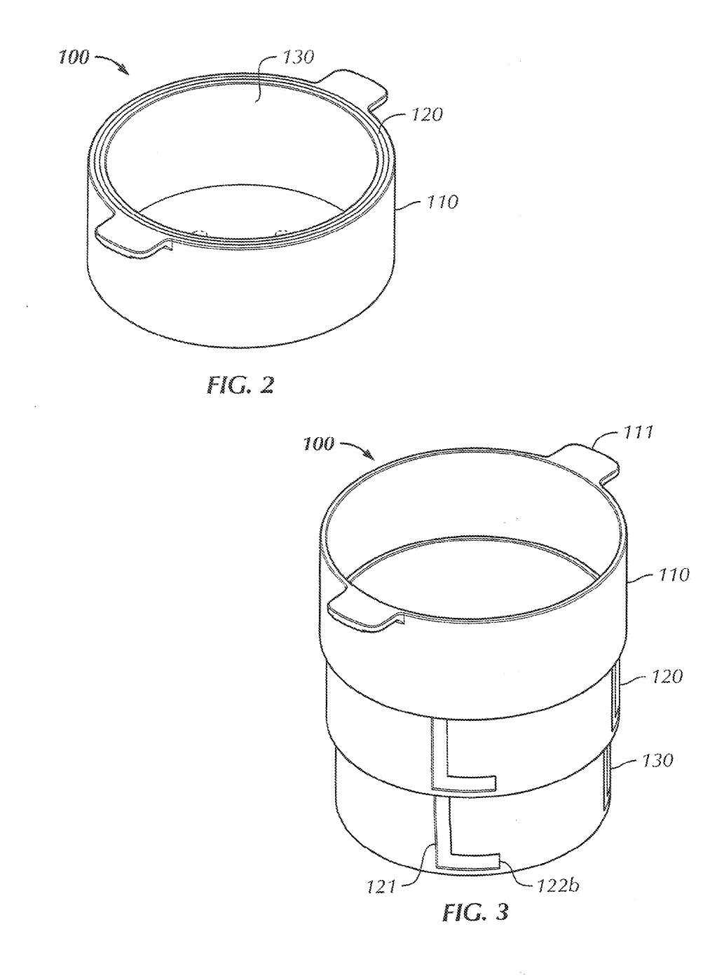

FIGS. 2 and 3 illustrate the concentric alignment of the inner most panel (130), intermediate panel (120) and the outer most panel (110). FIG. 2 shows a collapsible container configured with a single intermediate panel (120) in the collapsed position. The channels (121) and tabs (123) are not visible. FIG. 3 shows the same collapsible container configured with a single intermediate panel (120) in the expanded position.

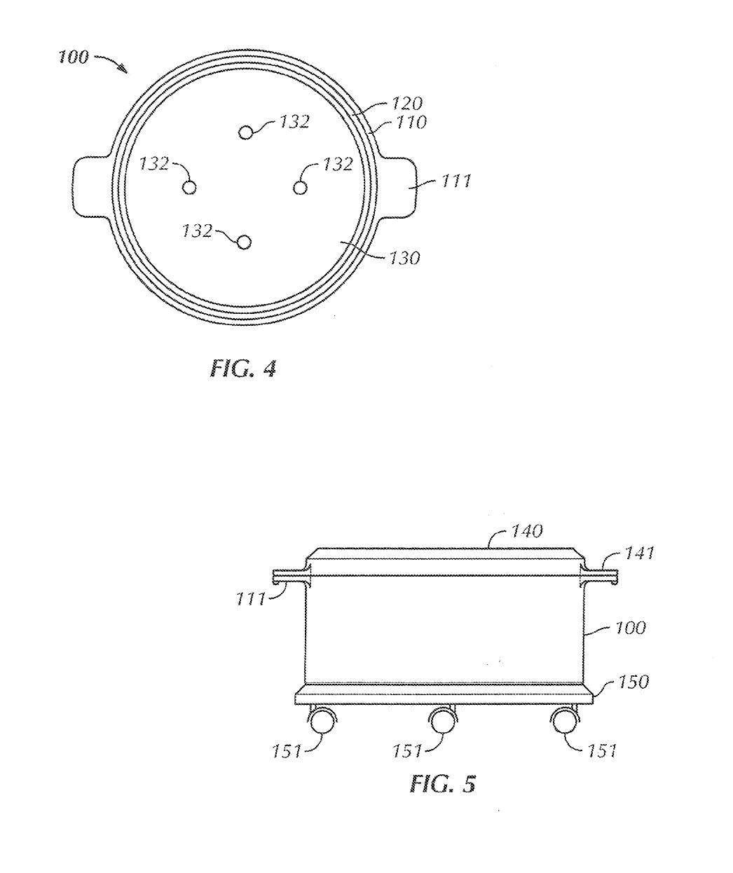

FIG. 4 shows a top view of a collapsible storage container. In this view the base attachment points (132) are visible at the bottom (131) of the inner most panel (130). Further, the handles (111) are illustrated on each side of the outer most panel (110).

FIG. 5 shows a side view of a collapsible storage container (100) in the collapsed position with attached base unit (150) and lid (140). In this view the lid (140) can be seen to have handles (141) which align and secure to the handles (111) of the storage container (100). The base (150) attaches to the bottom of the storage container (100) by means of the attachment points (132 & 152 not illustrated). Casters (151) are optionally attached to the base (150) to give the storage container (100) mobility.

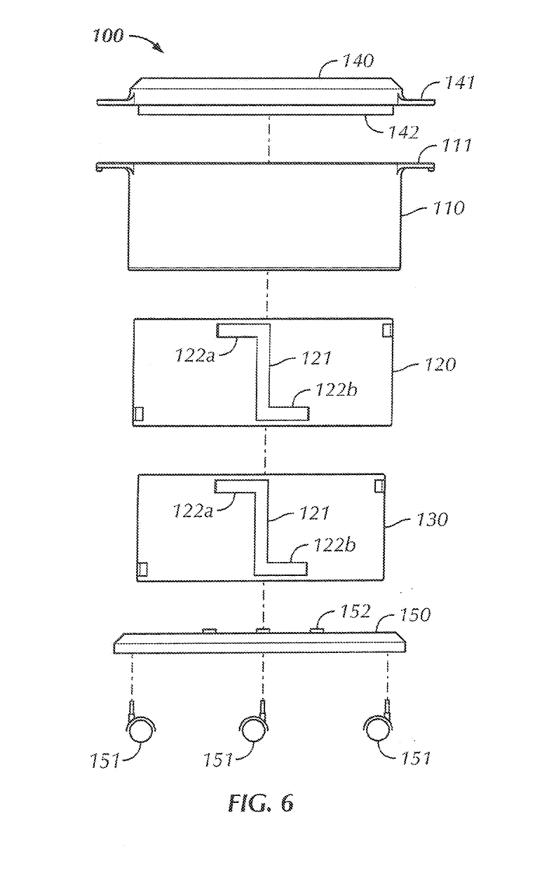

FIG. 6 shows an exploded side view of a collapsible storage container (100) with rolling base (150) and lid (140) in accordance with an exemplary embodiment of the invention. In this view the details of the storage container (100) are visible and are the same as discussed with regard to FIG. 1 above. In this view, the lid (140) is clearly illustrated in detail. In addition to the handles (141) discussed in the previous paragraph, one can see the rim (142) used to seal the lid (140) to the storage container (100). In this illustration the rim (142) uses an overlapping friction fit to connect to the interior of the outer most panel (110). One skilled in the art would appreciate other methods of securely attaching the lid (140) to the storage container (110), including but not limited to friction fit, threading, latched, pressure seals, etc.

Also clearly illustrated in detail is the base (150) which can be converted to a rolling base (150) by the attachment of casters (151) or slides (not illustrated). One skilled in the art would appreciate that there may be as few as three casters or as many as space allows with varying degrees of stability and mobility. On the top of the base (150) the attachment points (152) are shown. In this illustration the attachment points (152) are illustrated as oversized pins which snap in to the base attachment points (132, not illustrated) of the inner most panel (130). One skilled in the art would appreciate that other means can be used to attach the base (150) to the bottom of the storage container (100), including but not limited to: friction pins, screws, adhesive, Velcro, strapping, etc, or, the base could simply be created as a part of the inner most panel (130) of the storage container (100). This is accomplished by simply flaring out and thickening the bottom of the inner most panel (130) thus eliminating the need for attachment points (152, 132).

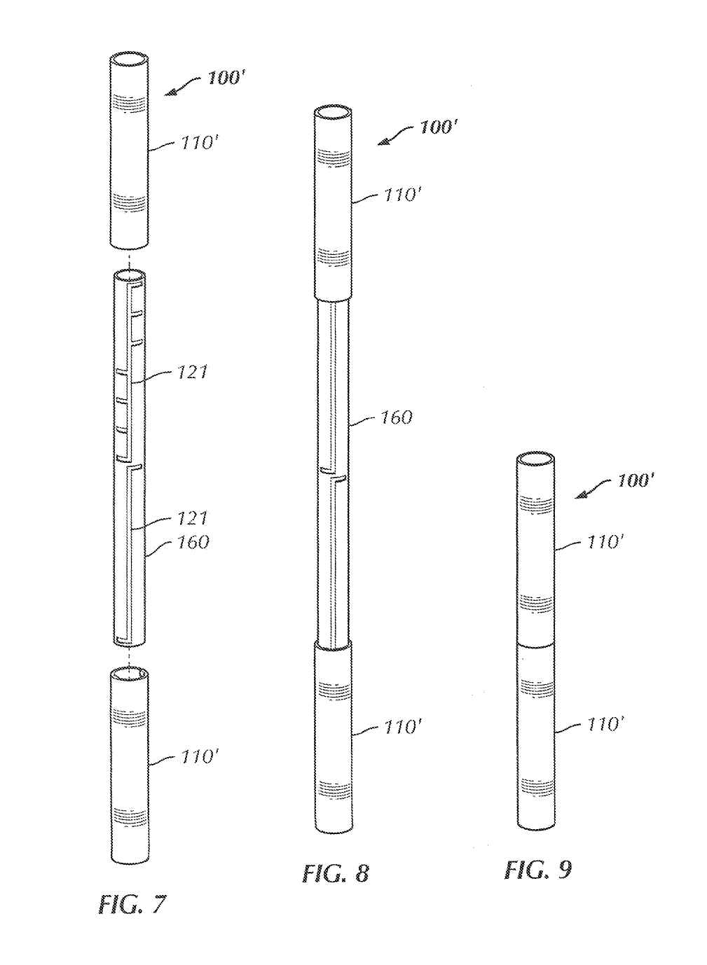

FIGS. 7, 8 and 9 show various views of a shipping tube in various configurations in accordance with an exemplary embodiment of the invention. Here, the storage container (100′) is illustrated with two outer most panels (110′) and a single intermediate panel (160) which is configured to have dual vertical channels (121) which each extend for approximately half the length of the intermediate panel (160). In one embodiment, at least one of the vertical channels (121) may have a plurality of angled side channels (122a and 122b, not illustrated) which allow the outer most panel (110′) to be locked into different intermediate positions thus varying the overall length of the storage container (110′). In this configuration a lower most panel (130, not illustrated) with its substantially closed end is not necessary. Lids (140, not illustrated) could be used at either end of the outer most panels (110′) as illustrated in previous figures. In another embodiment one of the outer most panels (110′) could be configured with a substantially closed end, and the distal outer most panel (110′) could utilize a lid (140, not illustrated) to secure the contents of the container.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity, such as the intermediate panel may actually be implemented in a plurality. Further, some element illustrated in the plurality, such as the three casters, could actually vary in count, such as the use of five casters. Further, some elements illustrated in one form, such as wheel caster, could actually vary in detail, such as the use of ball casters. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A multi-purpose container having a generally cylindrical shape;
comprised of sections of successively diminishing size, mating in a telescopic nature;
each section further comprising
a plurality of channels running perpendicular to the plane of the open end of each section;
with a protruding tab on the adjacent wall of the corresponding mating section,
said tab member traveling within the channel to guide the expanding or collapsing of the sections along a vertical direction.

2. A multi-purpose container, as described in claim 1 wherein the channel is angled at the top such that the tab can be diverted from the linear path of the main channel to lock the section against moving in the vertical direction thus locking the container in an open configuration.

3. A multi-purpose container, as described in claim 1 wherein the channel is angled at the bottom such that the tab can be diverted from the linear path of the main channel to lock the section against moving in the vertical direction thus locking the container in a closed configuration.

4. A multi-purpose container, as described in claim 1 further comprising a cover for closing off one end of the container.

5. A multi-purpose container, as described in claim 4 wherein the cover further comprises a latching mechanism for securing the cover to the container.

6. A multi-purpose container, as described in claim 1 further comprising a base which seals the bottom of the container.

7. A multi-purpose container as described in claim 1 comprised of
a top most ring having a plurality of handles;
a plurality of middle rings; and
a base having an extended lower edge to prevent the middle and top most rings from slipping past the base ring.

8. A multi-purpose container as described in claim 1 further comprising a bail type handle.

9. A multi-purpose container as described in claim 1 wherein said container is tight fitting such that the container is water tight.

10. A multi-purpose container as described in claim 1 further comprising a flexible liner for holding liquid within the extended container.

11. A multi-purpose container as described in claim 1 wherein the sections are interchangeable such that different collections of sections can be used to vary the capacity of the container.

12. A multi-purpose container as described in claim 1 comprised of a moldable plastic.

13. A multi-purpose container as described in claim 1 comprised of a fiberglass.

14. A multi-purpose container as described in claim 1 comprised of a metal.

15. A multi-purpose container as described in claim 1 comprised of a luminescent material.

16. A multi-purpose container as described in claim 1 wherein the sections are of different colors.

17. The method of using a collapsible container comprising sliding one or more telescopic sections by causing a plurality of tabs protruding from a surface of a section to slidingly travel along a channel with angled ends extending perpendicular to the main channel in the corresponding mating section.

18. The method of using a collapsible container as described in claim 17, further comprising extending one or more telescopic sections and twisting to de-align a plurality of tabs and channels thus locking the container in the open configuration.

19. The method of using a collapsible container as described in claim 17, further comprising twisting to align a plurality of tabs and channels thus enabling one or more telescopic sections to collapse into a closed configuration.

20. The method of using a collapsible container as described in claim 17, further comprising collapsing a plurality of telescopic sections and twisting to de-align a plurality of tabs and channels thus locking the container in the closed configuration.
